(19) United States
(12) Patent Application Publication
(10) Pub. No.: US 2022/0373424 A1
(43) Pub. Date: Nov. 24, 2022

(54) SYSTEM AND METHOD FOR LIQUID PROPANE QUICK CONNECT MEASURING MANIFOLD

(71) Applicant: Dustin Steven Forsling, Grand Junction, CO (US)

(72) Inventor: Dustin Steven Forsling, Grand Junction, CO (US)

(21) Appl. No.: 17/752,705

(22) Filed: May 24, 2022

Related U.S. Application Data
(60) Provisional application No. 63/192,529, filed on May 24, 2021.

(51) Int. Cl. G01M 3/26; F16L 37/02

(52) U.S. Cl. CPC G01M 3/26; F16L 37/02

(57) ABSTRACT

The present invention is directed to a system and method for a highly efficient manifold that connects to a pressure measurement apparatus for an RV propane system wherein the manifold is utilized for a quick connection without removal of a gas line whereby the manifold has quick coupling fittings or adapters to form a connection to the gas system and is utilized for a quick connection for a liquid petroleum timed pressure drop test, lock up test, and regulator adjustment without the need for tying into gas lines with hoses.

### CROSS REFERENCE TO RELATED APPLICATIONS

This application claims priority to U.S. Provisional Patent No. 63/192,529 filed on May 24, 2021.

### FIELD OF THE DISCLOSURE

This disclosure relates generally to the field of manifolds and more particularly to a quick connect device for pressure testing the complete LP system of an RV not requiring tying into a gas line.

### BACKGROUND

RVs require a certain amount of gas inlet pressure to operate normally and ensure there are no leaks in the RV LP system. When diagnosing performance issues associated with one or more appliances in the RV, a technician will need to check incoming pressure at a gas outlet using a pressure measuring device, such as a manometer, to diagnose any problems that could be associated with the gas inlet pressure and the integrity of the LP system. If the measured gas pressure at the gas outlet is acceptable or within predetermined requirements, then a technician will determine that gas pressure is not above or below required parameters and proceed to establish other possible sources of the problem. The technician will then perform the required timed pressure drop test to ensure the LP system has no leaks.

However, this process may take the technician twenty to 30 minutes to tie in the gas lines from the RV to have the gas system exposed and accessible for testing the gas system pressure using the pressure measuring device and then to reassemble the system as it was before. Thus exists a need for an improved system and method for a RV Propane Quick Connection Apparatus which allows the test to be completed without compromising the integrity of the test system and to reduce the test process to 7-10 minutes and ensures that the RV quick connect port adds a safety feature not requiring the LP system to be disconnected for the required 3 minute timed pressure drop test.

### SUMMARY

The present description is directed to a system and method for a highly efficient manifold that connects to a pressure measurement apparatus for an RV propane system whereby the manifold has quick coupling fittings or adapters to form a connection to the gas system and is utilized for a quick connection for a liquid petroleum timed pressure drop test, lock up test, and regulator adjustment without the need for tying into gas lines with hoses.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 shows an illustration of the easy manifold.

FIG. 2 shows another illustration of the easy manifold connected to a manometer.

### DETAILED DESCRIPTION

In the Summary above and in this Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility) and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit or a range having no lower limit depending upon the variable being defined). For example, “at most 4” means 4 or less than 4, and “at most 40%” means 40% or less than 40%. When, in this specification, a range is given as “(a first number) to (a second number)” or “(a first number)— (a second number),” this means a range whose lower limit is the first number and upper limit is the second number. For example, 25 to 100 mm means a range whose lower limit is 25 mm and upper limit is 100 mm.

Certain terminology and derivations thereof may be used in the following description for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

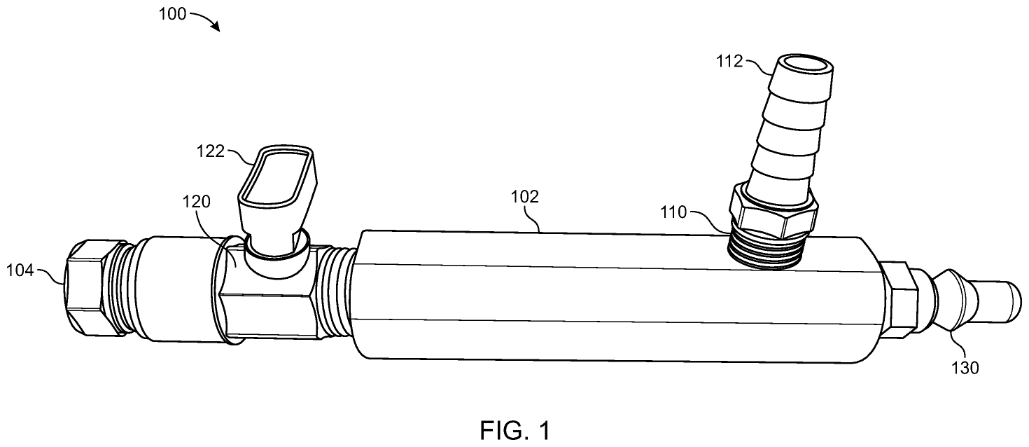

With reference now to FIG. 1, FIG. 1 illustrates one exemplary embodiment of manifold 100 with a plurality of gas outlets. The materials of construction of manifold may be brass, copper, aluminum, high strength low alloy steel, or stainless steel. The body of manifold 100 has a main cylindrical section 102 with a longitudinally extending through bore where the formed inner portion allows for flow passages. Cylindrical section 102 may have a drilled hole 104 which may be formed by a 5/64″ drill bit at one end of the tube whereby hole 104 is sized to simulate appliances running at 50%. Cylindrical section 102 may be intersected perpendicularly at a length by a gas outlet having an endpoint 110 whereby cylindrical section 102 may receive a hose connector 112 for coupling manifold 100 to a hose of a manometer.

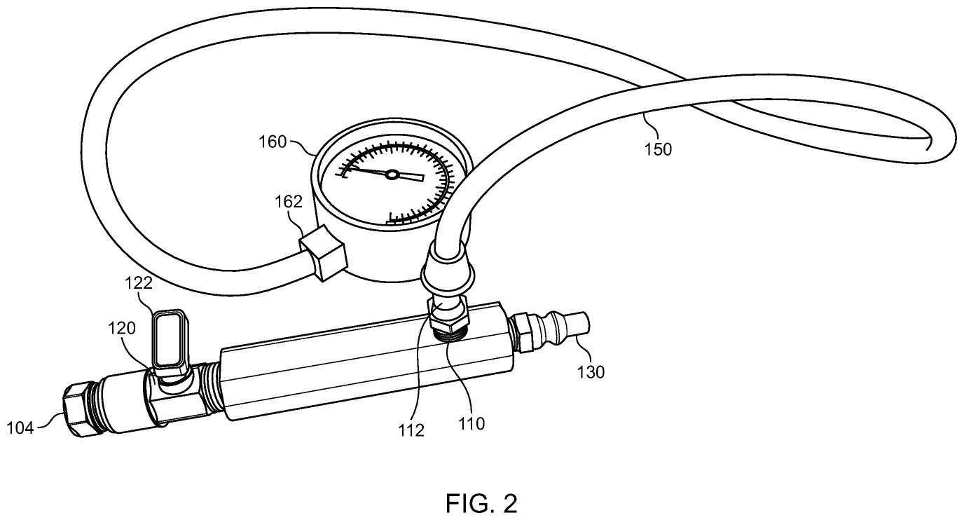

With reference to FIG. 2, an end of a hose 150 of a pressure measuring device, such as a manometer 160 (either U-tube, dial, digital, or straight), may be coupled to endpoint 110 of manifold 100, for example, by hose connector 112. The other end of the hose 150 may be coupled to a hose connector 162 of manometer 160. Hose connector 112 may be integrally formed to endpoint 110 or may be removably connected as a separate component. One of ordinary skill in the art will recognize that other arrangements can be provided for coupling manifold 100 to a hose 150 of a manometer 160 within the spirit and scope of the invention such as having manifold 100 directly connected to manometer 160 without a hose.

Cylindrical section 102 may be intersected perpendicularly at length by a valve mechanism 120. Valve mechanism 120 may be connected to manifold 100 by array of threaded studs with nuts and a sealing ring on each end or other types of fasteners. Valve mechanism 120 may utilize any number of valves such as a ball valve. The ball in the ball valve may have a smooth spherical sealing surface with a radially projecting reduced diameter cylindrical lower pivot pin on its lower side. The lower pivot pin is journaled in a pivot bore of cylindrical section 102. A diametrically extending through bore flow passage may be formed in ball that is perpendicular to the axis of the lower pivot pin. On its upper side, the ball has a transverse face perpendicular to the pivot axis and sufficiently offset from the mid height of the ball to permit spherical sealing. An upper pivot pin may extend radially upwardly from the transverse face of the ball. The upper transverse end of the upper pivot pin may have a central drilled and tapped extraction hole to simplify insertion and extraction of the ball from cylindrical section 102.

Valve mechanism 120 may be operated either manually or by means of an actuator 122. Actuator 122, which in some embodiments may be a handle, may be utilized for rotation for actuating valve mechanism 120 in a clockwise or counter clockwise direction. Actuator 122 may be connected to the upper pivot pin in a fixed relationship so that rotation of actuator 122 causes the pivot pin to rotate to allow for a selectable rotation for actuating for valve mechanism 120 such that the ball may be rotated and the valve mechanism 120 may either be opened or close.

Cylindrical section 102 may have quick connect fitting 130 at the second end that may be in the form push-to-connect fitting or having a threading mechanism that may be received by a low pressure quick connect port on a RV propane system without the removal or tying in in of gas lines.

In use, manifold 100 is connected to a low pressure quick connect port on an RV while endpoint 110 is connected to manifold 100 to conduct a timed pressure drop test, lockup test, and operating pressure test. The valve on the RV is opened to allow the gas from a tank to flow to manifold 100. The operating pressure of the RV may then be measured, which should read 11 inches of water column with valve mechanism 120 open, whereby the bored hole simulates 50 percent or more of the btu/hour flow rate of the appliances. A lockup pressure test may then be verified whereby valve mechanism 120 is closed, which should raise the lockup pressure reading to no more than 14 inches of water column with valve mechanism 120 closed. A lockup pressure reading higher than 14 inches of water column indicates that the regulator may be bad.

A timed pressure drop test may then be verified where the valve on the RV is closed. Valve mechanism 120 may then be opened to reduce the measured pressure on the manometer 160 to approximately 7½ to 8½ inches of water column, then valve mechanism 120 is turned off. After waiting a period of time if there is no drop in pressure the system is leak free. If the pressure drops any amount, then there is a leak somewhere in the system and further troubleshooting is required. If the pressure slowly increases, this may indicate either a rise in temperature or a problem with the propane cylinder's service valve that is not closing all of the way.

In further embodiments, the valve mechanism and other components may be controlled by a motor which may have an automatic electromechanical release mechanism used to control the actuator and monitor statistics of manifold 100. The electromechanical release mechanism may utilize a control system for remote activation of the release mechanism.

The control system may operate to control the actuation of the other systems. The control system may have a series of computing devices. The control system may be in the form of a circuit board, a memory, or other non-transient storage medium in which computer-readable coded instructions are stored and one or more processors configured to execute the instructions stored in the memory. The control system may have a wireless transmitter, a wireless receiver, and a related computer process executing on the processors.

Computing devices of the control system may be any type of computing device that typically operates under the control of one or more operating systems which control scheduling of tasks and access to system resources. Computing devices may be any computing device capable of executing instructions with sufficient processor power and memory capacity to perform operations of the control system.

The one or more computing devices may be integrated into the control system, while in other non-limiting embodiments, the control system may be a remotely located computing device or server configured to communicate with one or more other control systems. The control system may also include an internet connection, network connection, and/or other wired or wireless means of communication (e.g., LAN, etc.) to interact with other components. The connection allows a user to update, control, send/retrieve information, monitor, or otherwise interact passively or actively with the control system.

The control system may include control circuitry and one or more microprocessors or controllers acting as a servo control mechanism capable of receiving input from sensors and other components, analyzing the input from sensors and other components, and generating an output signal to components. The microprocessors (not shown) may have on-board memory to control the power that is applied to the various systems. The control system may be preprogrammed with any reference values by any combination of hardwiring, software, or firmware to implement various operational modes including, but not limited to, temperature, light, and humidity values.

The microprocessors in the control system may also monitor the current state of circuitry within the control system to determine the specific mode of operation chosen by the user including results of the timed pressure drop, lockup test, and operating pressure test. Further, such microprocessors that may be part of the control system may receive signals from any of or all systems.

The electromechanical release mechanism may include a wireless communication interface, which may be a digital, analog, or mixed-signal circuit to transmit wireless signals indicating user input received from electromechanical release mechanism. The wireless signals may be transmitted to a computing device such as a phone, a computer, a wearable device, tablet, a virtual reality system, etc. The wireless communication interface may send and receive data via a wireless network without the need for connecting a cable.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. A manifold that connects to a pressure measurement apparatus for an RV propane system wherein the manifold is utilized for a quick connection without removal of a gas line.

2. The manifold of claim 1, wherein the manifold has a main body with a longitudinally extending through bore wherein a formed inner portion allows for flow passages.

3. The manifold of claim 2, wherein the main body is intersected perpendicularly at a length by a gas outlet, the gas outlet having an endpoint.

4. The manifold of claim 3, further comprising a hose connector for coupling the gas outlet to a hose of a manometer or directly to the manometer.

5. The manifold of claim 4, wherein the main body has a drilled hole at a first end of the main body wherein the drilled hole is sized to simulate appliances running at 50%.

6. The manifold of claim 5, wherein the main body has a quick connect fitting at a second end.

7. The manifold of claim 6, wherein the quick connect fitting is in a form of a push-to-connect fitting receivable by a low pressure quick connect port on the RV propane system without the removal or tying in in of gas lines.

8. The manifold of claim 7, wherein the main body is intersected perpendicularly at a second length by a valve mechanism.

9. The manifold of claim 8, wherein the valve mechanism is connected to the main body by array of threaded studs with nuts and a sealing ring on each end.

10. The manifold of claim 9, wherein the valve mechanism is a ball valve mechanism.

11. The manifold of claim 9, wherein the valve mechanism has an actuator for actuating the valve mechanism in a clockwise or counter clockwise direction.

12. The manifold of claim 11, wherein the main body is cylindrical in shape.

13. A method for using a manifold that connects to a pressure measurement apparatus for an RV propane system without removal of a gas line, wherein the manifold has a main body with a longitudinally extending through bore wherein a formed inner portion allows for flow passages, wherein the main body is intersected perpendicularly at a length by a gas outlet, the gas outlet having an endpoint and a hose connector, wherein the main body has a drilled hole at a first end of the main body wherein the drilled hole is sized to simulate appliances running at 50%, wherein the main body has a quick connect fitting at a second end, wherein the main body is intersected perpendicularly at a second length by a valve mechanism.

14. The method of claim 13, further comprising: connecting a hose to the manifold.

15. The method of claim 14, further comprising: connecting a manometer to the hose.

16. The method of claim 15, further comprising: connecting the manifold to a low pressure quick connect port on an RV.

17. The method of claim 16, further comprising: opening the valve mechanism by an actuator.

18. The method of claim 17, further comprising: conducting an operating pressure test by opening a valve on the RV to allow gas from a tank of the RV to flow to the manifold, wherein an operating pressure is measured, which should read 11 inches of water column.

19. The method of claim 18, further comprising: conducting a lock up test by closing the valve mechanism which should raise the operating pressure to no more than 14 inches of the water column.

20. The method of claim 19, further comprising: conducting a timed pressure drop by closing the valve on the RV and opening the valve mechanism to reduce a measured pressure on the manometer to approximately 7½ to 8½ inches of the water column wherein then valve mechanism is turned off; and
waiting a period of time to determine if there is a drop in pressure to determine a leak.
